(19) United States
(12) Patent Application Publication
(10) Pub. No.: US 2024/0336169 A1
(43) Pub. Date: Oct. 10, 2024

(54) SEAT

(71) Applicant: TOYOTA BOSHOKU KABUSHIKI KAISHA, Aichi (JP)

(72) Inventors: Toshiaki FUKATSU, Anjo-shi (JP); Osamu IKAI, Owariasahi-shi (JP)

(73) Assignee: TOYOTA BOSHOKU KABUSHIKI KAISHA, Aichi (JP)

(21) Appl. No.: 18/616,667

(22) Filed: Mar. 26, 2024

(30) Foreign Application Priority Data
Apr. 10, 2023 (JP) 2023-063627

(51) Int. Cl. B60N 2/12

(52) U.S. Cl. CPC B60N 2/12

(57) ABSTRACT

A seat including a movable mechanism includes a metallic frame forming a framework of the seat; a metallic pin that is slidable within a hole formed in the frame and that is disposed as a part of the movable mechanism; and an elastically deformable resin collar that is disposed between an inner circumferential surface of the hole and an outer circumferential surface of the pin, and that is slidably contactable with at least one of the inner circumferential surface of the hole or the outer circumferential surface of the pin.

### CROSS-REFERENCE TO RELATED APPLICATIONS

This application claims the benefit of Japanese Patent Application No. 2023-063627 filed on Apr. 10, 2023 with the Japan Patent Office, the entire disclosure of which is incorporated herein by reference.

### BACKGROUND

The present disclosure relates to a seat including a movable mechanism.

For example, a vehicle seat disclosed in Japanese Patent No. 4595192 (hereinafter referred to as Patent Document 1) includes a movable mechanism utilizing a three-joint linkage mechanism. In this movable mechanism, a slidable pin that acts as a joint is displaced by sliding in an elongated hole.

### SUMMARY

In the invention disclosed in Patent Document 1, due to a gap between an inner circumferential surface of the elongated hole and the slidable pin, the slidable pin and the inner circumferential surface of the elongated hole collide with each other and generate abnormal noise when the slidable pin is displaced by sliding or when an excitation force is applied to the seat. In view of this problem, the present disclosure will disclose examples of a seat that can reduce the generation of abnormal noise.

According to one aspect of the present disclosure, it is preferable that a seat including a movable mechanism includes at least one of the following elements, for example. Such elements are a metallic frame forming a framework of the seat; a metallic pin that is slidable in a hole formed in the frame and that is disposed as a part of the movable mechanism; and an elastically deformable resin collar that is disposed between an inner circumferential surface of the hole and an outer circumferential surface of the pin and that is slidably contactable with at least one of the inner circumferential surface of the hole or the outer circumferential surface of the pin.

Collision between the inner circumferential surface of the hole and the outer circumferential surface of the pin is thereby prevented in the seat; and therefore, the generation of abnormal noise due to the collision of the pin with the inner circumferential surface of the hole can be reduced.

The seat may be configured as below, for example.

That is, it is preferable that a portion of the collar contacting the pin and a portion of the pin contacting the collar each include an inclined portion that is inclined relative to a longitudinal direction of the pin.

Consequently, even when an excitation force including a component in the longitudinal direction of the pin and a component in a direction orthogonal to the longitudinal direction is applied to the seat, the generation of abnormal noise due to such an excitation force can be reduced.

The pin includes a rod portion having a round-bar-shape, and a brim-shaped flange portion disposed on one end of the rod portion in the longitudinal direction. Each inclined portion is preferably disposed at a position where the rod portion and the flange portion are coupled to each other. The collar is preferably an integrated member formed integrally with the pin.

The frame preferably includes a burr portion formed on an outer rim of the hole. The burr portion includes a wall surface extending from the outer rim in a direction parallel to the longitudinal direction of the pin. Since the posture of the pin can be supported by the burr portion, the pin can be stably displaced by sliding.

### BRIEF DESCRIPTION OF THE DRAWINGS

Example embodiments of the present disclosure will be described hereinafter with reference to the accompanying drawings, in which:

FIG. 1 shows a vehicle seat of a first embodiment;

FIG. 2 shows a front-end side of the vehicle seat of the first embodiment;

FIG. 3 shows the front-end side of the vehicle seat of the first embodiment;

FIG. 4 shows the front-end side of the vehicle seat of the first embodiment; and

FIG. 5 shows a tilt pin of the first embodiment.

### DETAILED DESCRIPTION OF EXEMPLARY EMBODIMENTS

Following embodiments of the invention represent examples of embodiments that fall within the technical scope of the present disclosure. In other words, mattes to specify the invention or the like recited in the claims are not limited to any specific configuration, structure, or the like described in the following embodiments.

The present embodiments show examples where a seat in the present disclosure is applied to a seat provided to be assembled to a vehicle such as a car (hereinafter referred to as “vehicle seat”). Arrows for indicating directions, oblique lines, or the like in each drawing are provided to facilitate understanding of mutual relations between the drawings, the shapes of members or portions, or the like.

Therefore, orientation of the vehicle seat is not limited to how the vehicle seat is oriented in each drawing. The directions in each drawing are provided to show the orientation of the vehicle seat of the present embodiments when it is assembled to a car. A drawing with the oblique lines does not necessarily represent a cross-sectional view.

With respect to at least a member or a portion explained with a reference numeral, at least one of such a member or a portion is disposed unless it is described using a term such as “only one of”. In other words, unless it is described using a term such as “only one of”, two or more of such a member or a portion may be disposed. The vehicle seat of the present disclosure includes at least one of elements, such as at least a member and a portion explained with reference numerals, or a structural component shown in the drawings.

### First Embodiment

### <1. Outline of Vehicle Seat>

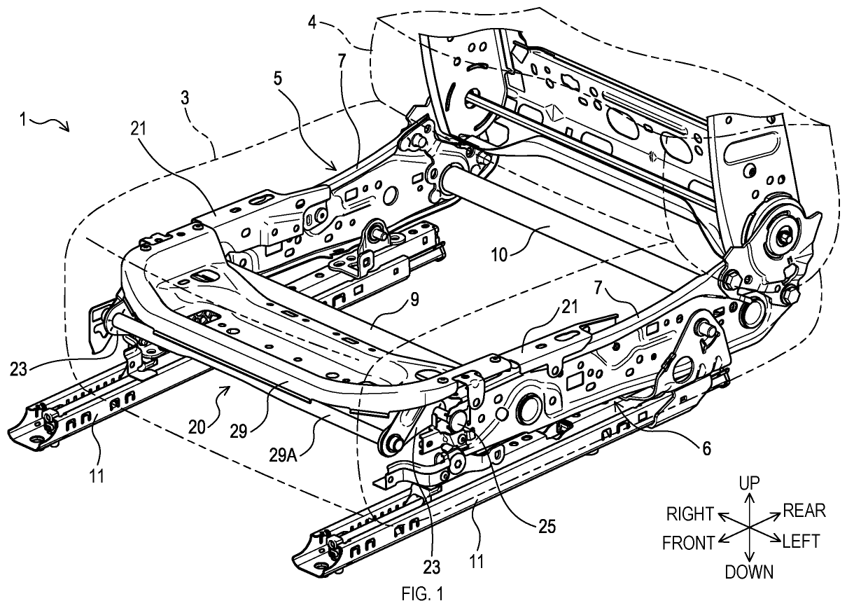

As shown in FIG. 1, a vehicle seat 1 includes at least a seat cushion 3, and a seatback 4. The seat cushion 3 is a portion for supporting the buttocks of an occupant. The seatback 4 is a portion for supporting the back of the occupant.

The seat cushion 3 includes a cushion frame 5 and a cushion pad made of urethane or the like (not illustrated). The cushion frame 5 forms a framework of the seat cushion 3. The cushion frame 5 includes members such as a frame main body 6, and a tilt unit 20.

The frame main body 6 includes at least two side frames 7, and coupling members 9, 10. The first side frame 7 is a metallic reinforcing member that is arranged on one end-side of the cushion frame 5 in seat-width directions (left-end-side in FIG. 1) and that extends in front-rear directions of the seat.

The second side frame 7 is a metallic reinforcing member that is arranged on the other end-side of the cushion frame 5 in the seat-width directions (right-end-side in FIG. 1) and that extends in the front-rear directions of the seat. The coupling members 9, 10 extend in the seat-width directions (right-left directions in FIG. 1) and couple the two side frames 7 together.

The frame main body 6 of the present embodiment is fixed to a vehicle body via two sliding devices 11. Each of the sliding devices 11 is for displacing the vehicle seat 1 in a manner parallel to the front-rear directions of the seat.

The tilt unit 20 is one example of the movable mechanism and is a mechanism to make an inclination angle of a front end of the seat cushion 3 changeable. The tilt unit 20 is mounted to a front end of the frame main body 6. In other words, the tilt unit 20 is mounted to front ends of the side frames 7.

### <2. Tilt Unit>

### <2.1 Configuration of Tilt Unit>

As shown in FIG. 1, the tilt unit 20 includes at least two tilt arms 21, two pivot arms 23, two tilt pins 25, a front panel 29, and a coupling member 29A.

The first tilt arm 21 extends in the front-rear directions of the seat. A rear end of the first tilt arm 21 is pivotably coupled to the first side frame 7. Likewise, the second tilt arm 21 extends in the front-rear directions of the seat, and a rear end of the second tilt arm 21 is pivotably coupled to the second side frame 7.

Thus, when the two tilt arms 21 pivot relative to the respective side frames 7, the inclination angle of the front panel 29, situated in the front end of the seat cushion 3, is changed. The front panel 29 and the coupling member 29A couple front ends of the two tilt arms 21 to each other.

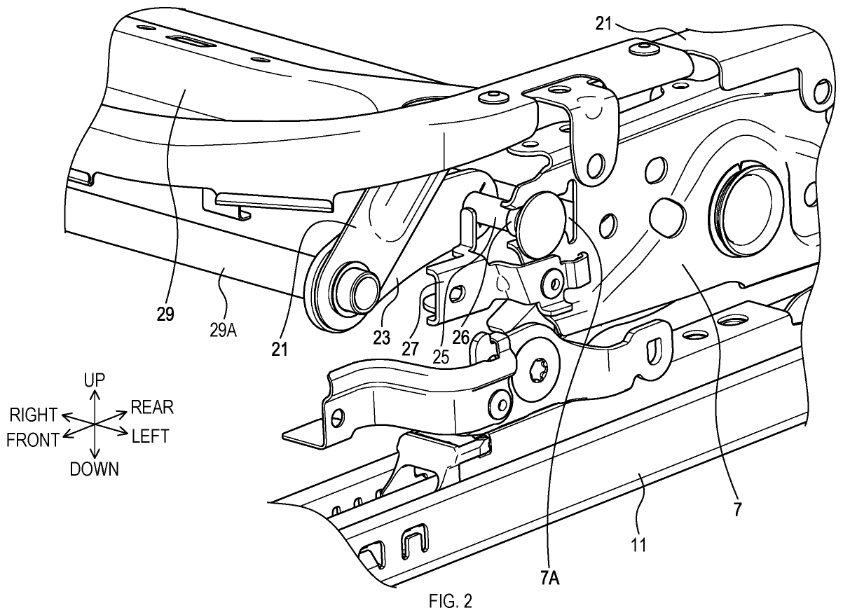

As shown in FIG. 2, the two pivot arms 23 are for pivotably displacing the corresponding tilt arms 21. Front ends of the pivot arms 23 are pivotably coupled to the front ends of the tilt arms 21. Rear ends of the pivot arms 23 are pivotably coupled to the corresponding side frames 7.

Each of the tilt pins 25 rotatably couples the corresponding pivot arm 23 to the corresponding side frame 7. Each tilt pin 25 is disposed anterior to a connection point between the side frame 7 and the tilt arm 21, and extends in the seat-width directions.

Either one of the two pivot arms 23 (the pivot arm 23 on the other end-side in the seat-width directions in the present embodiment) comprises a sector gear. An electric motor (not illustrated) is fixed to the tilt arm 21 to which the sector gear is coupled.

The tilt pin 25 is integrated with the sector gear, or the pivot arm 23 on the other end-side in the seat-width directions, by welding or other process. Accordingly, when the electric motor rotates, the sector gear rotates about the tilt pin 25.

When the pivot arm 23 on the other end-side pivots, the pivot arm 23 on the one end-side mechanically synchronizes via the coupling member 29A and the front panel 29 and pivots. At this time, since the two tilt arms 21 pivot in conjunction with the two pivot arms 23, the inclination angle of the front end of the seat cushion 3 changes.

### <2.2 Supporting Structure of Tilt Pin>

The supporting structure of the tilt pin 25 on the one end-side in the seat-width directions is the same as the supporting structure of the tilt pin 25 on the other end-side in the seat-width directions. The following explains the supporting structure of the tilt pin 25 on the one end-side in the seat-width directions.

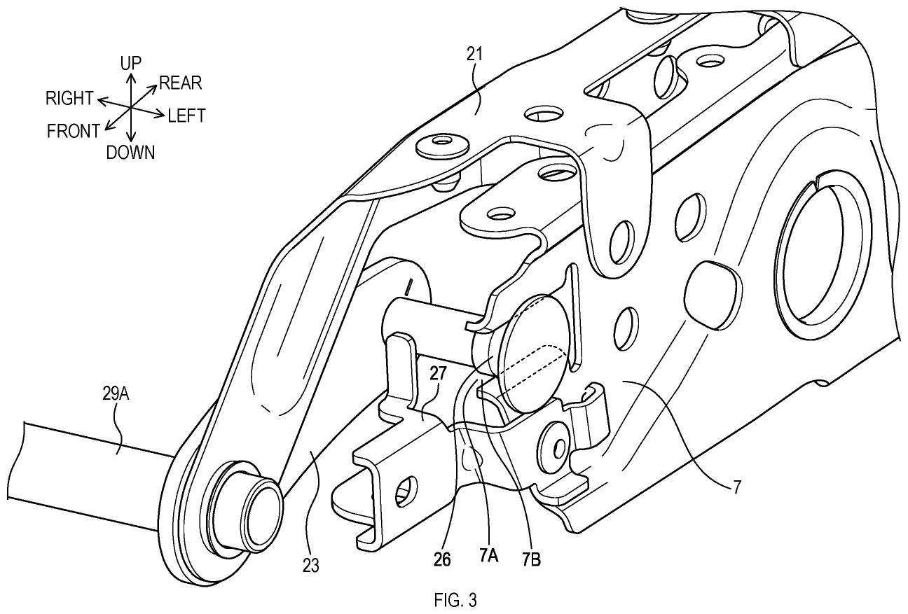

As shown in FIG. 3, a through hole 7A formed through the side frame 7 in the seat-width directions is disposed in the front end of the side frame 7. The through hole 7A is a concaved or U-shaped through hole recessed rearward from a front end 7B of the side frame 7.

The through hole 7A of the present embodiment has an elongated aperture, a major-axis direction of which substantially agrees with an extending direction of the side frame 7. The tilt pin 25 is inserted through the through hole 7A. The tilt pin 25 can thus rotate while sliding in the through hole 7A in the major-axis direction.

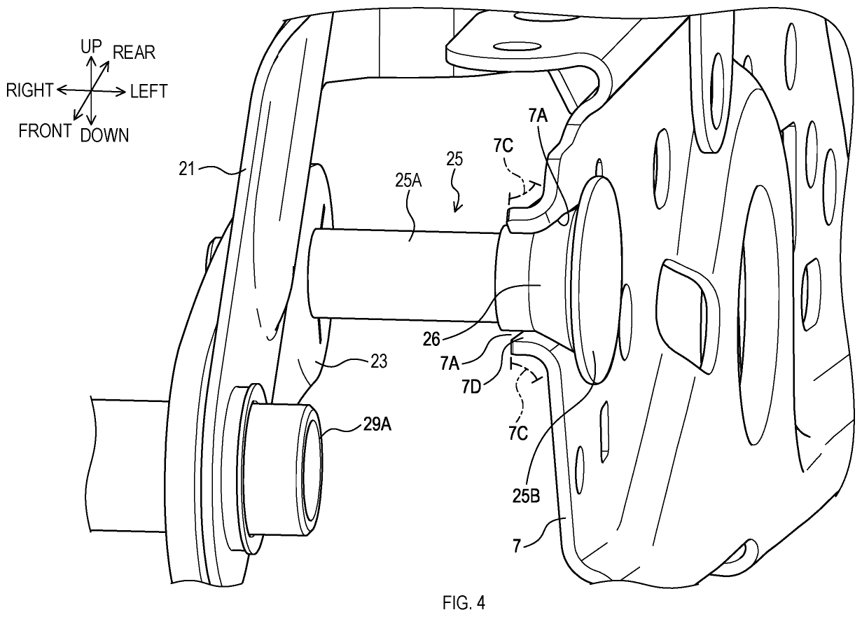

A falling-off preventing member 27 is disposed in a leading end of the side frame 7. The falling-off preventing member 27 prevents the tilt pin 25 from falling off from an open end of the through hole 7A. As shown in FIG. 4, an extended portion 7C is formed on an outer rim of the through hole 7A.

The extended portion 7C is an example of a burr portion that has a wall surface 7D extending from the outer rim in a direction parallel to a longitudinal direction of the tilt pin 25. The extended portion 7C is an integrated member formed integrally with the side frame 7 at the time of pressing for molding the through hole 7A or by burring after the pressing.

As shown in FIG. 4, a collar 26 is disposed between an inner circumferential surface of the through hole 7A and an outer circumferential surface of the tilt pin 25. The collar 26 is an elastically deformable resin member slidably contactable with at least one of the inner circumferential surface of the through hole 7A or the outer circumferential surface of the tilt pin 25.

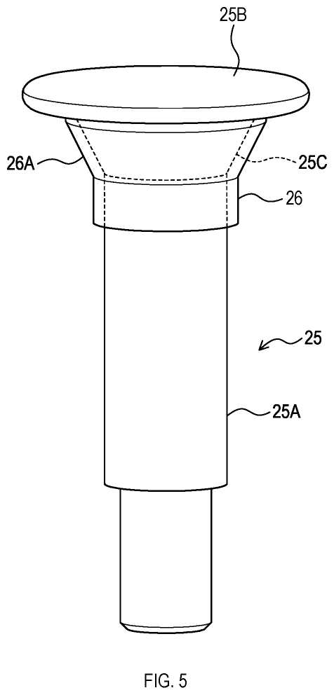

In other words, as shown in FIG. 5, the tilt pin 25 includes a rod portion 25A having a round-bar-shape, and a flange portion 25B having a brim-shape. The flange portion 25B is disposed on one end of the rod portion 25A in the longitudinal direction.

An inclined portion 25C that is inclined relative to the longitudinal direction of the rod portion 25A is disposed at a position where the rod portion 25A and the flange portion 25B are coupled to each other. The collar 26 is disposed at least on the inclined portion 25C.

Accordingly, in the present embodiment, a portion of the collar 26 contacting the tilt pin 25 and a portion of the tilt pin 25 contacting the collar 26 respectively include an inclined portion 26A and an inclined portion 25C that are inclined relative to the longitudinal direction of the tilt pin 25.

In the present embodiment, the collar 26 is an integrated member formed integrally with the tilt pin 25. More specifically, the collar 26 is integrated with the tilt pin 25 by the insert molding method.

### <3. Characteristics of Vehicle Seat (Particularly of Supporting Structure of Tilt Pin) of Present Embodiment>

The resin collar 26 is disposed between the inner circumferential surface of the through hole 7A and the outer circumferential surface of the tilt pin 25. The resin collar 26 is elastically deformable and slidably contactable with at least one of the inner circumferential surface of the through hole 7A or the outer circumferential surface of the tilt pin 25.

Accordingly, in the vehicle seat 1, collision between the inner circumferential surface of the through hole 7A and the outer circumferential surface of the tilt pin 25 is prevented; and therefore, the generation of abnormal noise due to the collision of the tilt pin 25 with the inner circumferential surface of the through hole 7A can be reduced.

A portion of the collar 26 contacting the tilt pin 25 and a portion of the tilt pin 25 contacting the collar 26 respectively include the inclined portion 26A and the inclined portion 25C that are inclined relative to the longitudinal direction of the tilt pin 25.

Consequently, even when an excitation force including a component in the longitudinal direction of the tilt pin 25 (the seat-width directions in the present embodiment) and a component in a direction orthogonal to the longitudinal direction is applied to the vehicle seat 1, the generation of abnormal noise due to such an excitation force can be reduced.

The through hole 7A includes, on its outer rim, the extended portion 7C that includes the wall surface 7D extending from the outer rim in a direction parallel to the longitudinal direction. Since the extended portion 7C can thereby support the posture of the tilt pin 25, the tilt pin 25 can be stably displaced by sliding.

### OTHER EMBODIMENTS

The aforementioned embodiment was an example where the tilt unit 20 acts as the movable mechanism. However, the present disclosure is not limited thereto. In other words, the present disclosure can be applied to movable mechanisms other than the tilt unit 20.

In the aforementioned embodiment, the tilt pin 25 is configured to rotate as it slides. However, the present disclosure is not limited thereto. In other words, in the present disclosure, the tilt pin 25 may be configured to be non-slidable or non-rotatable, for example.

In the aforementioned embodiment, the collar 26 is disposed on the inclined portion 25C. However, the present disclosure is not limited thereto. In other words, in the present disclosure, the collar 26 may have a simple cylindrical shape, for example.

In the aforementioned embodiment, the outer rim of the through hole 7A includes the extended portion 7C that includes the wall surface 7D extending from the outer rim in a direction parallel to the longitudinal direction. However, the present disclosure is not limited thereto. In other words, in the present disclosure, the extended portion 7C may be eliminated, for example.

In the aforementioned embodiment, the collar 26 is an integrated member formed integrally with the tilt pin 25. However, the present disclosure is not limited thereto. In other words, in the present disclosure, the collar 26 and the tilt pin 25 may be separate parts.

In the aforementioned embodiment, the vehicle seat of the present disclosure is applied to a car. However, application of the present disclosure is not limited thereto. In other words, the present disclosure may be applied to a seat used in vehicles such as railroad vehicles, ships and boats, and aircrafts, and also to a stationary seat used in theaters and households, for example.

Furthermore, the present disclosure is only required to coincide with the invention recited in the claims and thus should not be limited to the aforementioned embodiments. Therefore, the present disclosure may include a configuration obtained by combining at least two of the aforementioned embodiments, or a configuration obtained by eliminating either one of the elements in the drawings or the elements described with reference numerals in the aforementioned embodiments.

What is claimed is:

1. A seat including a movable mechanism, the seat comprising:
a metallic frame forming a framework of the seat;
a metallic pin that is slidable in a hole formed in the frame and that is disposed as a part of the movable mechanism; and
an elastically deformable resin collar that is disposed between an inner circumferential surface of the hole and an outer circumferential surface of the pin, and that is slidably contactable with at least one of the inner circumferential surface of the hole or the outer circumferential surface of the pin.

2. The seat according to claim 1,
wherein a portion of the collar contacting the pin and a portion of the pin contacting the collar each comprise an inclined portion that is inclined relative to a longitudinal direction of the pin.

3. The seat according to claim 2,
wherein the pin comprises a rod portion having a round-bar-shape, and a brim-shaped flange portion disposed on one end of the rod portion in the longitudinal direction, and
wherein each inclined portion is disposed at a position where the rod portion and the flange portion are coupled to each other.

4. The seat according to claim 2,
wherein the collar is formed integrally with the pin.

5. The seat according to claim 2,
wherein the frame comprises a burr portion on an outer rim of the hole, and
wherein the burr portion comprises a wall surface extending from the outer rim in a direction parallel to the longitudinal direction.

6. The seat according to claim 3,
wherein the collar is formed integrally with the pin.

7. The seat according to claim 3,
wherein the frame comprises a burr portion on an outer rim of the hole, and
wherein the burr portion comprises a wall surface extending from the outer rim in a direction parallel to the longitudinal direction.
